(19) United States
(12) Patent Application Publication
(10) Pub. No.: US 2009/0293473 A1
(43) Pub. Date: Dec. 3, 2009

(54) Stirling Engine Assembly and Methods of Assembly Such an Assembly

(75) Inventors: Christopher John Spenceley, Yattendon (GB); David Anthony Clark, Ramsey (GB)

Correspondence Address: Ballard Spahr LLP, SUITE 1000, 999 PEACHTREE STREET, ATLANTA, GA, 30309-3915, US

(73) Assignee: MICROGEN ENERGY LIMITED, Reading (GB)

(21) Appl. No.: 11/922,802

(22) PCT Filed: Jun. 20, 2006
(86) PCT No.: PCT/GB2006/002254

§ 371 Date: Jun. 30, 2009

(30) Foreign Application Priority Data
Jun. 21, 2005 (GB) 0512672.7

(51) Int. Cl. F02G 1/04; B23P 15/00

(52) U.S. Cl. 60/524; 29/888.02

(57) ABSTRACT

A Stirling engine (1) to which an annular burner (2) is attached and is sealed to the engine by a flexible annular sealing member (5). An annular coolant channel (4) in the form of an annular coolant channel member (24) with a U-shaped cross-section attached to a mounting bracket (3) cools the seal (5). The channel member (24) has an upwardly extending annular flange (29) to shield the interface between the burner (2) and mounting bracket (3). An annular lip (33) extends from a lower region of the coolant channel (24) and the top of the sealing member (5) is fitted around this lip. The sealing member (5) is fitted in place after the coolant channel member (24) has been mounted to the bracket (3).

The present invention relates to a Stirling engine assembly comprising a mounting bracket, a burner attached to the mounting bracket, a Stirling engine attached to the mounting bracket, the engine having a head which is positioned, in use, within the burner, an annular sealing member to seal an annular gap between the burner and the Stirling engine, and a coolant channel surrounding the Stirling engine positioned to cool the sealing member. Such an assembly will subsequently be referred to as “of the kind described”.

An assembly of the kind described is disclosed in WO 03/098025. This addresses the problem of how to seal the annular gap between the engine and the burner. A number of considerations apply to this seal. The engine will vibrate slightly with respect to the burner housing and mounting bracket, and the seal should be configured so as not to transmit this vibration to the surrounding components, for example mounting points, an enclosure or a casing. Also, in view of the proximity between the burner and the seal, the seal must be able to withstand high temperatures without degradation. WO 03/098025 solves these problems by providing a flexible seal and positioning a coolant circuit between the burner and the seal to reduce the heat transfer to the seal. This arrangement reduces the temperature to which the seal is exposed thereby allowing the use of conventional seal materials.

The present invention is directed to various improvements of this assembly.

According to a first aspect of the present invention, an assembly of the kind described is characterised in that the coolant channel comprises an annular channel member open at its upper face and being fixed to the mounting bracket so that the mounting bracket seals the channel member and, with the channel member, forms the coolant channel.

In WO 03/098025 the coolant channel was formed by a channel member open at its lower surface which was bolted to an annular plate with the sealing member sandwiched between these two components to seal the coolant channel. By fixing the annular channel directly to the mounting bracket to provide a sealed channel, the structure of the channel is simplified.

The annular channel member is preferably fixed to the mounting bracket by a permanent (i.e. irreversible) fixing. This is preferably a fused joint such as a brazed or welded joint. By providing a fused joint, the need for a separate sealing member to seal the channel is removed thereby further simplifying the assembly. In addition, the permanent fixing provides a more rigid bracket which is more effective in preventing the transmission of noise and vibration from the engine to the surrounding components/environment.

According to a second aspect of the invention, an assembly of the kind described is characterised in that the coolant channel has an upwardly extending annular flange at its radially innermost edge, the flange extending upwardly in a central opening in the mounting bracket to shield the interface between the burner and mounting bracket.

This flange protects the interface between the burner and the mounting bracket from radiated heat from the burner. Thus, if a separate sealing member such as a gasket is required between the mounting bracket and the burner, the temperature which this component must be designed to withstand is reduced thereby permitting use of a cheaper material. Further, as the flange extends from the coolant channel, the heat radiated to the flange from the burner is readily conducted away by the coolant in the channel, reducing heat lost to the surroundings.

According to a third aspect of the present invention an assembly of the kind described is characterised in that an annular lip extends from a lower region of the coolant channel, wherein a lower portion of the sealing member seals with respect to the engine and an upper portion of the sealing member is fitted around the annular lip and seals with respect to the burner.

This lip assists in providing a secure seal between the engine and burner.

Preferably the annular lip extends upwardly and is inclined back towards the engine. Also preferably, the annular lip terminates in a radially outwardly extending portion.

Preferably the assembly further comprises an upper clamping band surrounding the upper portion of the seal to clamp the upper portion between the annular lip and the upper clamping band. Alternatively, or preferably additionally, the assembly further comprises an annular plate fixed to the engine below the head, and a lower clamping band surrounding the lower portion of the seal to clamp the lower portion between the annular plate and the lower clamping band. This provides a simple and secure sealing arrangement.

The annular lip may be an integral part of the coolant channel, but is preferably a separate component fixed to the coolant channel.

According to this fourth aspect there is provided a method of assembling a Stirling engine assembly comprising a mounting bracket, a burner attached to the mounting bracket and a Stirling engine having a head which is positioned, in use, within the burner, the method comprising the steps of fixing a coolant channel to the bracket beneath the burner, and subsequently fixing a flexible seal between the channel and the engine.

In WO 03/098025, an engine module is assembled with the coolant channel and seal preassembled to the engine. This module is then separately attached to the engine mounting bracket. The attachment of the coolant channel to the bracket before the seal is attached to the channel greatly simplifies the assembly operation as the channel can be fixed in place without hindrance from the engine or the seal.

Preferably, the flexible seal is fitted to the channel before being fitted to the engine. This allows the seal to be preassembled to the channel. In this case, it is preferable for the seal to be fitted to the channel before the head of the Stirling engine is inserted into the burner. In such an arrangement, the burner, bracket, channel and seal can be assembled as a first sub-assembly. The engine can then be inserted into its operating position and the seal can be completed simply by attaching the seal with respect to the engine.

The coolant channel is preferably permanently mounted to the bracket by a fused joint, for example by welding or brazing as described in relation to the first aspect of the invention. Also, preferably, the coolant channel is provided with the upwardly extending flange as described in relation to the second aspect of the invention and also the upwardly extending annular lip and clamping bands as described in relation to the third aspect of the invention.

It should be noted that while all four aspects of the invention may be used independently of one another, two or more aspects of the invention may be combined.

An example of the various aspects of the present invention will now be described with reference to the accompanying drawings, in which:

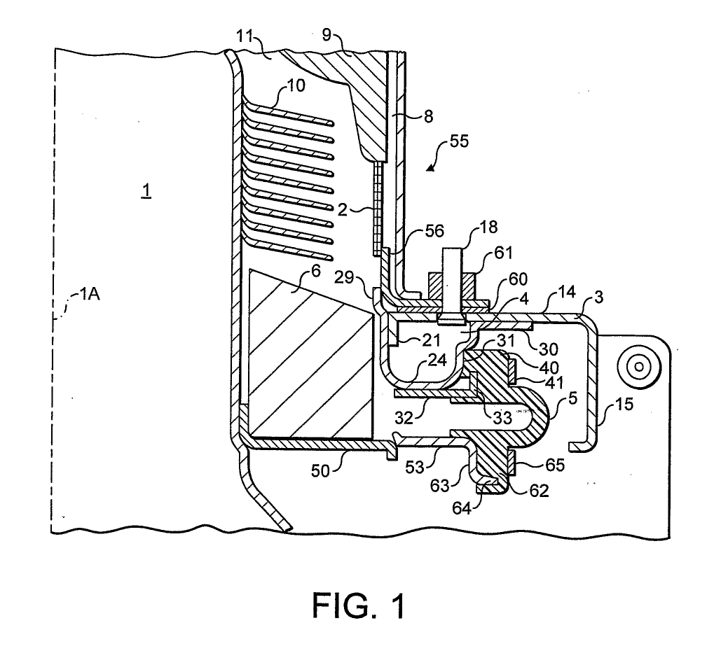

FIG. 1 is a cross section through part of a Stirling engine head, the burner, the coolant channel, mounting bracket and flexible seal;

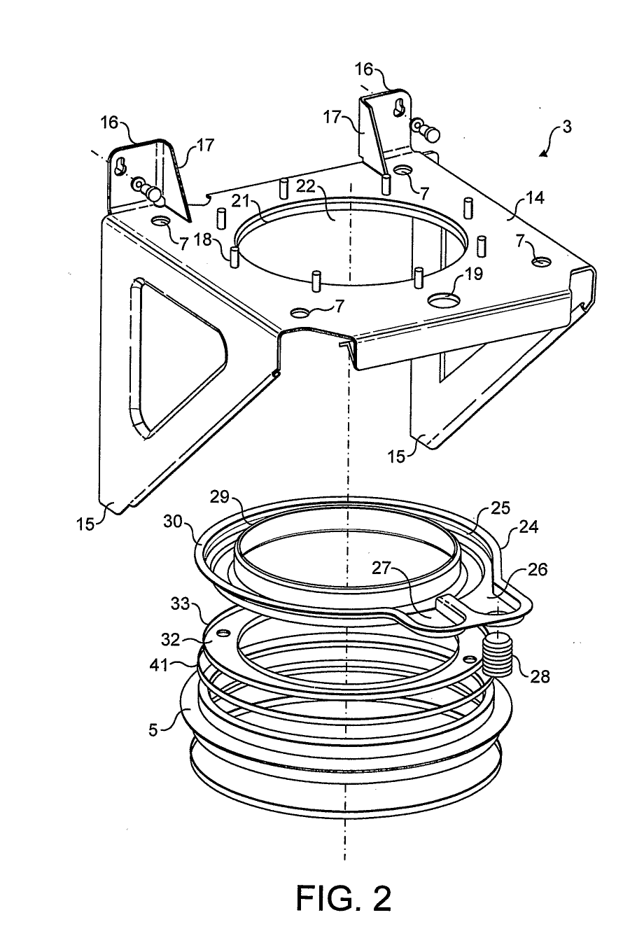

FIG. 2 is an exploded perspective view showing the mounting bracket, coolant channel and flexible seal; and

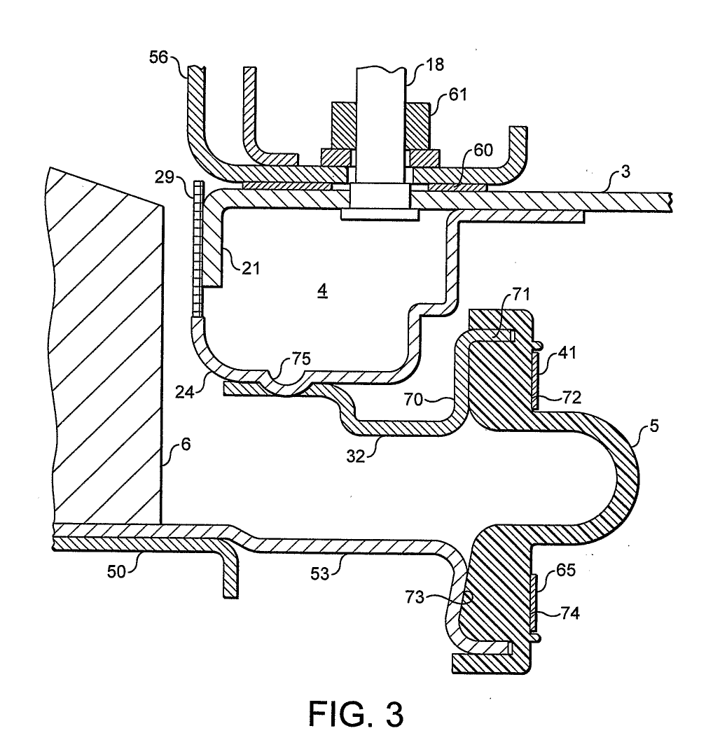

FIG. 3 is a cross section of a second example of a seal assembly.

The overall arrangement of the Stirling engine assembly is described, for example, in WO 03/098025 and will not be described further in detail here:

The invention is solely concerned with the interface between the Stirling engine and burner and this will be described with reference to FIG. 1. This shows a Stirling engine 1 which is centred around a main axis IA. Only the right hand side of the Stirling engine, burner and seal are shown in FIG. 1 as the left hand side is simply a mirror image.

The basic components of the assembly are the Stirling engine 1, a burner 2 surrounding the engine head, a mounting bracket 3 on which the burner 2 is mounted, a coolant channel 4 mounted to the underside of the bracket 3 and a flexible seal 5 which seals the interface between the burner 2 and Stirling engine 1 to prevent burner gases escaping around the engine and into the surrounding air. An annular block of insulation 6 is provided to hinder the downward transfer of heat from the burner.

The Stirling engine 1 is mounted on a plurality of springs as described in WO 03/042566, has a plurality of engine suspension points 7 as shown in FIG. 2. Alternatively, the engine may be suspended from a separate component. The present invention is not concerned with the exact nature of the engine suspension and it will not be described in detail here. Suffice to say that, despite the measures disclosed, for example, in WO 03/042566 to reduce the vibrations of the engine, inevitably the engine 1 will vibrate to a small extent with respect to the mounting bracket 3. This is the reason why the flexible seal 5 is provided.

In operation, a gas and air mixture is fed to the burner 2 along inlet channel 8. This is preheated in a recuperator 9 as it comes into thermal contact with exhaust gas emitted from the engine in an upper part of the recuperator not shown in FIG. 1. The gas is ignited at burner 2 and the hot combustion gas is directed onto a plurality of fins 10 thereby heating the Stirling engine head and allowing the Stirling engine to operate as is well known in the art.

The engine is designed such that the majority of the hot gas flows out along exhaust passage 11 where by heat is recovered to pre-heat the incoming gas/air, and to provide space and water heating. However a small proportion of this heat inevitably travels downwards by conduction, convection and radiation towards the seal 5 between the burner 2 and engine 1.

A number of measures have been taken in order to minimise the temperature to which the seal 5 is exposed. Firstly, as will be appreciated from FIG. 1, the seal 5 is positioned some distance away from the burner 2, and the passage from the burner 2 to the seal 5 is tortuous. Secondly, the burner 5 is positioned in a region in which its external surface is open to the ambient surroundings allowing a certain amount of air cooling of the seal. Thirdly, an annular block of insulation reduces significantly the conductive heat flow in a direction of the seal. The block 6 also takes up most of the physical space between the engine and the burner providing the tortuous path for any burner gases thereby reducing the convective heat flow. However, it will be appreciated that the block 6 cannot approach the surrounding housing too closely or it will contact the housing as the engine vibrates thereby causing unwanted transmission of vibrations into the casing external to the engine. Lastly, the coolant channel 4 circulates a flow of coolant around the head and is physically spaced between the burner 2 and the engine 5.

As is well known in the art, a separate engine coolant circuit is provided around a central portion of the Stirling engine to extract heat from the engine to allow the thermal cycle to operate. The water circulated through coolant channel 4 is preferably connected to this engine coolant circuit either in series or in parallel. Alternatively, an entirely separate coolant may be used.

As described so far, the engine is much as described in WO 03/098025.

The novel assembly method and novel features of the invention will now be described.

The assembly is comprised of two main sub-assemblies, namely the bracket sub-assembly and engine sub-assembly. The bracket sub-assembly is shown in FIG. 2. The engine mounting bracket 3 is pressed from a steel plate and is folded to form the 3D shape as shown in FIG. 2. Alternatively, the bracket sides may be pressed separately and brazed or welded to the top of the bracket. This bracket is then fixed to a room sealed box as described in Wo 04/101982. The bracket 3 comprises an engine/burner support surface 14 with two downwardly independent side support members 15, a pair of mounting tabs 16 project upwardly from the rear edge of the supporting surface 14, and each tab leads into a strengthening rib 17, the lower surface of which contacts the support surface 14. As described previously, the support surface 14 has a plurality of engine suspension points 7 from which the engine is mounted. It is also provided with a number of mounting studs 18 for the burner module as described below. These studs 18 are pushed through holes in the bracket and welded in place.

A coolant outlet orifice 19 is also provided in this support surface 14 and is again described in more detail below. The mounting bracket 3 has a downwardly depending annular lip 21 surrounding a central orifice 22.

A coolant channel member 24 is formed (for example cast) with a continuous annular duct 25, a coolant inlet 26 and a coolant outlet 27. A divider (not shown) is positioned across the annular duct 25 between the inlet and outlet to ensure that water passes into the inlet 26 around the annular duct 25 and out through the outlet 27. An inlet duct 28 is fixed to the inlet 26 and the outlet 27 is aligned with outlet orifice 19 in the mounting bracket. An outlet duct (not shown) is sealed to the coolant outlet orifice 19 to convey the coolant water away from the seal.

The cross-sectional shape of the cooling channel member 24 is shown in more detail in FIG. 1. The channel has a generally U-shape cross section. At the radially innermost edge, the channel is provided with an upwardly extending annular flange 29 which is offset radially inwardly from the inner wall of the channel as shown in FIG. 1. At its radially outermost edge, the channel terminates at a radially extending flange 30. The lowermost and radially outermost corner of the channel is provided with a recess 31.

In order to attach the coolant channel member 24 to the bracket 3, the two components are brought together in the position shown in FIG. 1. In this configuration, the downwardly depending annular lip 21 of the bracket 3 abuts against an upper portion of the inner surface of the radially innermost face of the channel 4, while the radially extending flange 30 of the channel abuts against the under surface of the mounting bracket 3. Both of these contact regions are welded or brazed thereby fixing the coolant channel member to the bracket 3 and providing the sealed coolant channel 4.

It can be seen from FIG. 1 that this provides a way of creating a coolant channel which requires minimal components, and does not require any of the separate sealing members of WO 03/098025. The welded or brazed channel member 24 also serves to reinforce the mounting bracket 3.

A seal mounting lip 32 is attached (for example by brazing or spot welding) to the bottom surface of the channel 4. The seal mounting lip has a flat annular configuration with an upstanding lip 33 at its radially outermost edge. When attached to the coolant channel member 24, the lip 33 extends upwardly into the recess 31 as shown in FIG. 1. The mounting bracket 3, channel member 24 and sealing lip 32 thus provide a single rigid assembly. These components are preferably all made of the same material (e.g. stainless steel, such as corrosion resistant 304 stainless steel) to eliminate any electrolytic corrosion problems which might otherwise occur.

Once these components are assembled, the flexible seal 5 is fitted to this assembly. The flexible seal is made of a polymer and has an annular configuration as shown in FIG. 2 with a cross section shown in FIG. 1. The uppermost portion 40 of the seal extends radially inwardly and terminates with a downwardly extending portion and is fitted in place as shown FIG. 1 over the lip 33 of the seal mounting lip 32. The seal is then secured in place by an upper steel clamping band 41.

The engine assembly will now be described with reference to FIG. 1. An inner burner seal plate 50 having an annular configuration is brazed to the engine casing 52 at the same time as the fins 10 are brazed to the head. An outer burner seal plate 53 again having an annular configuration is then passed over the fins 10 and is fixed in place, either by brazing, welding, soldering, or a combination of bolts and a gasket to the inner burner seal plate 50. This two part design of the burner seal plate prevents the plate distorting during the braze process. However, by more carefully controlling the braze process, a single burner seal plate could be used.

In order to fix a burner module 55 (consisting of burner 2, recuperator 9 and lower mounting flange 56) to the mounting bracket 3, the burner module is placed over the mounting bracket 3 so that the mounting studs 18 project through corresponding holes in the mounting flange 56. A gasket 60 seals the interface between the mounting bracket 3 and the burner module 55. The burner module is secured in place by a nut 61 on each stud 18. As can be seen from FIG. 1, the annular flange 29 extending upwardly from the coolant channel 4 effectively covers the gasket 60 thereby protecting it from heat radiated from the burner 2.

In order to complete the assembly of the overall system, the mounting bracket 3 (either with the burner module attached or attached in a subsequent step) is placed over the engine 1. The engine is then suspended from the bracket 3 at the engine suspension points 7 by springs (not shown). A lower portion 62 of the flexible seal 5 is then fitted to the outermost portion of the outer burner seal plate 53. At its outer edge, this extends to a downwardly extending portion 63 and terminates in a radially outwardly extending portion 64. A lower clamping band 65 holds the seal firmly against the downwardly extending portion 63. As can be seen in FIG. 1, the lowermost edge of the seal extends around the radially outwardly extending portion 64.

Leakage detection is provided to detect for the leakage of any hot gases between the inner and outer burner seal plates 50, 53. This is done by simple bimetallic temperature switches on the underside of the outer engine seal plate 53. If no leakage is present the temperature is relatively low as there is no flow path via this junction for hot gases to follow. Should leakage occur, hot gases would flow down from the burner raising the temperature below the plate 53. The bimetallic switches then trip providing a warning or automatically shutting down the engine.

A second example of a seal is shown in FIG. 3. Similar components have been identified by the same reference numerals which have been used in relation to FIG. 1. It will be immediately appreciated that the example shares many common features with the example of FIG. 1 and only the differences are set out here.

The seal mounting lip 32 has a different configuration. An upwardly extending portion 70 extends upwardly towards, the channel 4 and is angled by a small angle (for example 5 degrees) towards the engine. This provides a non-vertical surface which reduces slipping of the seal. The plate 32 terminates in a radially outwardly extending annular flange 71 which serves to support the seal. Clamping ring 41 holds the seal against the mounting lip 32 in a similar manner to the first example. A recess 72 is provided in the seal to accommodate the clamping band 41.

A similar inclined surface 73 is provided on seal plate 53 and a similar recess 74 is provided in the lower part of the seal.

A number (for example 3) of dimples 75 are provided around the lower surface of the cooling channel which mate with corresponding dimples in the seal mounting lip 32 to ensure that the engine is mounted concentrically within the cooling channel. The seal 5 is the only physical link between the engine collars and the burner/recuperator so that any misalignment will result in uneven circumferential clearances between components giving potential contact during operation.

The annular flange 29 does not extend upwardly as far as the corresponding flange 29 in FIG. 1. The flange 29 still shields the gasket 60, but to a lesser degree than in FIG. 1. In this case, the gasket 60 may be a nickel-graphite material instead of the ceramic of the previous example to compensate for the reduction in shielding.

1. A Stirling engine assembly comprising a mounting bracket, a burner attached to the mounting bracket, a Stirling engine attached to the mounting bracket, the engine having a head which is positioned, in use, within the burner, an annular sealing member to seal an annular gap between the burner and the Stirling engine, and a coolant channel surrounding the Stirling engine positioned to cool the sealing member; characterised in that the coolant channel comprises an annular channel member open at its upper face and being fixed to the mounting bracket so that the mounting bracket seals the channel member and, with the channel member, forms the coolant channel.

2. An assembly according to claim 1, wherein the annular channel member is fixed to the mounting bracket by a permanent fixing.

3. An assembly according to claim 2, wherein the permanent fixing is a fused joint.

4. An assembly according to claim 1, wherein the mounting bracket and channel member are made of the same material.

5. An assembly according to claim 1 Amended, wherein the coolant channel has an upwardly extending annular flange at its radially innermost edge, the flange extending upwardly in a central opening in the mounting bracket to shield the interface between the burner and mounting bracket.

6. A Stirling engine assembly comprising a mounting bracket, a burner attached to the mounting bracket, a Stirling engine attached to the mounting bracket, the engine having a head which is positioned, in use, within the burner, an annular sealing member to seal an annular gap between the burner and the Stirling engine, and a coolant channel surrounding the Stirling engine positioned to cool the sealing member; characterised in that the coolant channel has an upwardly extending annular flange at its radially innermost edge, the flange extending upwardly in a central opening in the mounting bracket to shield the interface between the burner and mounting bracket.

7. An assembly according to claim 6 wherein the mounting bracket and coolant channel are made of the same material

8. A Stirling engine assembly comprising a mounting bracket, a burner attached to the mounting bracket, a Stirling engine attached to the mounting bracket, the engine having a head which is positioned, in use, within the burner, an annular sealing member to seal an annular gap between the burner and the Stirling engine, and a coolant channel surrounding the Stirling engine positioned to cool the sealing member; characterised in that an annular lip extends from a lower region of the coolant channel, wherein a lower portion of the sealing member seals with respect to the engine and an upper portion of the sealing member is fitted around the annular lip and seals with respect to the burner.

9. An assembly according to claim 8, wherein the annular lip extends upwardly and is inclined back towards the engine.

10. An assembly according to claim 9, wherein the annular lip terminates in a radially outwardly extending portion.

11. An assembly according to claim 8, further comprising an upper clamping band surrounding the upper portion of the seal to clamp the upper portion between the annular lip and the upper clamping band.

12. An assembly according to claim 8 Amended, further comprising an annular plate fixed to the engine below the head, and a lower clamping band surrounding the lower portion of the seal to clamp the lower portion between the annular plate and the lower clamping band.

13. An assembly according to claim 8, wherein the mounting bracket and coolant channel are made of the same material.

14. A method of assembling a Stirling engine assembly comprising a mounting bracket, a burner attached to the mounting bracket and a Stirling engine having a head which is positioned, in use, within the burner, the method comprising the steps of fixing a coolant channel to the bracket beneath the burner, and subsequently fixing a flexible seal between the channel and the engine.

15. A method according to claim 14, wherein the flexible seal is fitted to the channel before being fitted to the engine.

16. A method according to claim 14, wherein the seal is fitted to the channel before the head of the Stirling engine is inserted into the burner.

17. A method according to claim 14, wherein the coolant channel is permanently mounted to the bracket by a fused joint.
